(19) United States
(12) Patent Application Publication
(10) Pub. No.: US 2003/0229963 A1
(43) Pub. Date: Dec. 18, 2003

(54) Mobile heated-fluid vacuum unit

(76) Inventors: James T. Broehl, The Dalles, OR (US); Eric P. Folkestad, Camas, WA (US)

Correspondence Address: KOLISCH HARTWELL, P.C., 520 S.W. YAMHILL STREET, SUITE 200, PORTLAND, OR, 97204, US

(21) Appl. No.: 10/172,594

(22) Filed: Jun. 14, 2002

(51) Int. Cl. F01P 1/00; G05D 23/00; A47L 7/00

(52) U.S. Cl. 15/320; 165/297; 165/51; 15/321

(57) ABSTRACT

A self-contained heated vacuum system designed for mounting in a vehicle, including a liquid-cooled engine, a shaft-driven blower, dual, counter-flow heat exchangers, engine exhaust diversion assembly, a temperature-controlled vacuum switch, and a three way toggle switch. Dual heat exchangers, a low pressure engine coolant heat exchanger and a high pressure engine exhaust heat exchanger, heat cleaning solution. In order to limit solution output temperatures, a diversion assembly may channel engine exhaust to bypass the high pressure engine exhaust heat exchanger and travel directly to a muffler by which it is expelled from the vacuum system. When actuated, a vacuum switch pulls a flapper valve located in the diversion assembly that redirects engine exhaust. Vacuum switch temperature selection is controlled by a three-way toggle switch, which presets the possible switching temperatures and alternately selects the operational temperature from among them.

### BACKGROUND OF THE INVENTION

The present invention relates generally to vacuum systems that can be mounted into vehicles and that incorporate heated fluid for cleaning purposes. More specifically, the invention relates to such a system that is particularly satisfactory due both to improved means of conveyance and to enhanced performance, the latter of which is achieved in part by utilizing the benefits of self-contained, shaft-driven technology in conjunction with an exhaust-diverting temperature control system.

Mobile heated vacuum systems have been in use for many years in carpet cleaning applications. Such units, which utilize a heated fluid for cleaning purposes and a powerful vacuum system for subsequent drying, are generally referred to as “truckmounts” due to their common means of transport as truck or van payloads. Truckmount systems are frequently moved in this manner from one site to another by a service provider in order to perform cleaning or restoration tasks. Due to their mobility, truckmounts are able to deliver powerful, professional-grade operation of which smaller, hand-held vacuum systems are incapable. Although the heated fluid within a truckmount, which is often a cleaning solution, will be referred to as ‘solution’ for the purposes of this disclosure, it should be understood that the fluid may also be water or some other liquid.

In order for truckmounts to perform optimally and to maximize their commercial benefits, it is desirable for such systems to operate portably, powerfully, dependably, and both efficiently and consistently at high solution temperatures. In direct correspondence to these desirable features, various truckmounts can be easily differentiated from each other with respect to housing, horsepower, drive mechanism, engine cooling method, and solution heating system. As a result, the respective merits of the related art will be evaluated as they relate to each of these characteristics.

Due to the number and size of components that are necessary for their successful function, self-contained “slide-in” truckmounts are unavoidably heavy pieces of equipment. As a result, in order for a truckmount to be safely and conveniently loaded on a vehicle, or transferred from one mounting position to another, it is essential that it should be no heavier than is required and that the structural housing within which it is enclosed should be suitable for transport and conveyance. Truckmounts are commonly designed without proper attention being given to these considerations, and heavy, bulky, inadequately reinforced units are often the result. Consequently, a need exists in the art for housing designs that eliminate excessive awkwardness of transport.

Truckmounts can be conveniently categorized in three major classes according to horsepower. Within this disclosure, low-, mid- and high-range systems will be referred to as those possessing engines with horsepower ratings of 0-30, 31-60 and 61 and greater, respectively. When considered solely with respect to their available power, high-range systems naturally appear to be preferable to either low- or mid-range alternatives. However, when mobility and economy are added as evaluative criteria, mid-range truckmounts quickly prove to be advantageous. Such units can generally provide a desirable cost/benefit ratio by supplying power levels that are adequate for most cleaning applications, unlike many low-range models, while not incurring the drawbacks of diminished fuel economy and mobility to which large-horsepower models are more susceptible.

Examples of related art in the low, mid and high truckmount power ranges are, respectively:

1) the Fox Truckmount Model 5000, sold by Organic Compounds of 1265 West 16^{th} Street, Long Beach, Calif., 90813,

2) the Pro 1900, sold by White Magic Inc. of 31 Main Street, Salisbury, Mass., 01952, and

3) the Vortex 590 Dual Wand System, sold by Vortex Systems of 10942 South Cindy Circle, Sandy, Utah, 84092.

The Fox Truckmount Model 5000, which relies on a Kohler 20 horsepower air-cooled engine, is unable to heat the cleaning solution without the use of an additional “Little Giant” propane burner. The addition of either propane or kerosene heaters on low-horsepower truckmounts is a common practice, which dramatically decreases the heat efficiency of such systems. In contrast, mid-range truckmounts often incorporate heat-exchangers that heat the solution with engine and blower heat, thereby maintaining optimal heat efficiency.

While high-range truckmounts, such as the Vortex 590, are also able to incorporate heat exchangers, they are neither as economical, due to their greater fuel consumption, nor as versatile, due to their greater size and weight, as mid-range truckmounts. In fact, the Vortex 590 is a 175 horsepower truckmount driven by a Power Take Off system engaged to the engine of a truck or van. Such truckmounts are commonly referred to as “direct-drive” units, in contrast to “slide-in” units which are self-contained truckmounts capable of being transferred from one vehicle to another. Direct drive truckmounts forfeit the valuable flexibility of slide in units because they are bound to a single truck or van. This meaning of the term ‘direct-drive’ should not be equivocated with the distinct term ‘direct drive-shaft mechanism’. The Performer 805, sold by Prochem of 325 South Price Road, Chandler, Ariz., 85244, is an example of a large horsepower, slide-in truckmount. However, the Performer 805's 65 horsepower Nissan engine causes the truckmount to weigh one ton, requiring it to be specially mounted on a box truck. Consequently, in terms of their economy and versatility, mid-range slide-in truckmounts are often preferable to high-range truckmounts, whether of the slide-in or direct-drive variety.

The dependability of a truckmount depends to a great extent upon the manner of drive mechanism that supplies power to its pump and blower components. Truckmounts commonly employ belt drives to power both their pumps and blowers. While the use of belt drives may be justified in conjunction with plunger pumps because it allows such pumps to be easily stepped-up and run at an rpm which varies from that of the engine, no similar reason exists in the case of blowers. On the contrary, truckmounts that incorporate belt-driven blowers are inherently susceptible to undesirable belt slippage, wear, and maintenance needs. In contrast, well-designed shaft-driven blowers can provide powerful, reliable operation without falling prey to the disadvantages that often accompany belt drive mechanisms.

As has been taught to a limited extent, both the solution heating method and the engine cooling method play a vital role in determine the heat efficiency of a truckmount unit. Several methods of heating the cleaning solution exist. Some units, such as the previously cited Fox Truckmount 5000, incorporate a propane burner for this purpose. Comparable truckmounts, whether they use a propane or kerosene burner or an independent heating mechanism of another sort, are often inferior to truckmounts which use heat exchangers to efficiently heat the solution.

In heat exchangers, such as those of the previously cited Pro 1900, the solution to be heated flows through a coiled, copper pipe enclosed by a larger pipe containing the chosen heating medium. Generally, the heating medium is the engine coolant, engine exhaust or blower exhaust. While it is common for truckmounts to employ any of these heat media, both the engine coolant and engine exhaust provide more abundant heat than the blower exhaust, so it would be beneficial to the art as a whole to further develop the deferential exploitation of these sources. In a counter-flow heat exchanger, the axial flow of the solution is in the opposite direction from that of the waste heat source. This counter-flow design doubly ensures that the solution encounters the heating medium at its coolest when it initially enters the heat exchanger and that it is heated gradually until exiting the exchanger having just established thermal contact with the heating medium at its maximum temperature. In this manner, waste heat is transferred to the cleaning solution, and energy efficiency is optimized.

The superior heat efficiency of counter-flow heat exchange systems is also directly relevant to the selection of the proper engine cooling method. Liquid-cooled engines allow for the conservation of waste energy by utilizing the engine cooling agent in a secondary function as the heating medium of a heat exchanger. In contrast, air cooled systems squander this valuable, readily available energy source by allowing waste heat to merely dissipate into the air. As a result, liquid-cooled engines have often been used for truckmounts.

Not only the range, but also the consistency of solution temperatures produced by truckmounts is essential for optimal performance in cleaning and restoration capacities. It is a truckmount's solution-heating system which is responsible for determining the consistency of the temperature at which the heated solution can be maintained. As a result, the solution temperature level and variation in a heat exchange truckmount naturally depends on the operation of its heat exchangers themselves—the function of which, in turn, depends on the temperature level and variation of its waste heat sources. However, while the running temperature of an engine and blower may fluctuate due to many outside factors, a means is needed by which the solution output can be maintained at a relatively constant temperature.

To fulfill this function, it is possible to use an automatic heat exchanger diversion method. In the related art, the previously cited Pro 1900, the 9100 LX, sold by Steamway International, 4550 Jackson Street, Denver, Colo., 80216, and the previously cited Vortex 590 each incorporate some such method. The Pro 1900 uses a vacuum-actuated switch to control a bypass solenoid which governs engine exhaust diversion. The 9100 LX incorporates a solenoid to enable a vacuum actuator which, in turn, pulls the engine exhaust diverter valve.

The diversion system of the Vortex 590 is superior to either of these techniques because it avoids the use of a solenoid—an electrical device which may be more prone to failure than alternate mechanical components. While the diversion system of the Vortex 590 does switch thermostatically, it fails to maintain such simplicity and reliability of design with respect to its temperature governance method. The successful operation of the truckmount's thermostatic diversion system depends upon an intricate digital control mechanism and a display to which it is coupled. The interdependent nature of this system compounds the complexity and thereby diminishes the dependability of its continued, consistent operation. Consequently, alternative heat exchanger diversion systems that to depend upon simplified designs and result in more reliable operation are highly desirable in the art of truckmounted fluid cleaning systems. In short, the development of truckmount systems which combine the desirable characteristics of a durable housing, mid-range horsepower, shaft-drive technology, liquid engine cooling, and a simplified heat exchange exhaust diversion mechanism would be highly beneficial to the art as a whole.

### BRIEF SUMMARY OF THE INVENTION

The present invention provides a self-contained heated vacuum system designed for mounting in a vehicle. The invention includes: a liquid-cooled engine, a shaft-driven blower, dual, counter-flow heat exchangers, an engine exhaust diversion assembly, a temperature-controlled vacuum switch, and a three way toggle switch. The dual heat exchangers are a low pressure engine coolant heat exchanger and a high pressure engine exhaust heat exchanger. The diversion assembly may channel engine exhaust to bypass the high pressure engine exhaust heat exchanger and travel directly to a muffler by which it is expelled from the vacuum system. The vacuum switch, when actuated, pulls a flapper valve located in the diversion assembly to alternately direct engine exhaust toward or away from the high pressure heat exchanger. The three-way toggle switch presets the possible switching temperatures of the vacuum switch and alternately selects the operational switching temperature from among them.

### BRIEF DESCRIPTION OF THE FIGURES

FIG. 1 is a solution flow diagram of an embodiment of a truckmount constructed according to the present invention, with dual counter-flow heat exchangers and an exhaust diversion valve.

FIG. 2 is an exploded perspective view of an embodiment of the structural and housing components of a truckmount constructed according to the present invention.

FIG. 3 is a front elevation view of an embodiment of a faceplate, including depictions of the gauges, dials, inlets, and outlets, of a truckmount constructed according to the present invention.

FIG. 4 is a right side elevation view of an embodiment of the interior of a truckmount constructed according to the present invention.

FIG. 5 is a rear elevation view of an embodiment of the interior of a truckmount constructed according to the present invention.

FIG. 6 is a left side elevation view of an embodiment of the interior of a truckmount constructed according to the present invention.

FIG. 7 is a partial rear perspective view of an embodiment of the interior of a truckmount constructed according to the present invention.

### DETAILED DESCRIPTION OF THE PREFERRED EMBODIMENTS

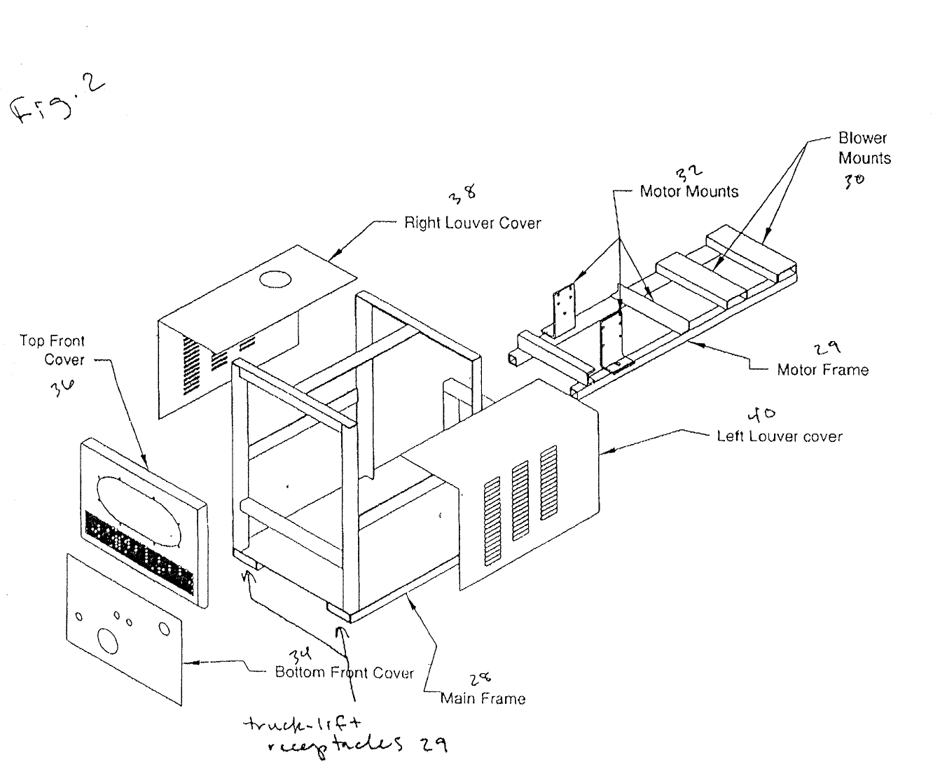

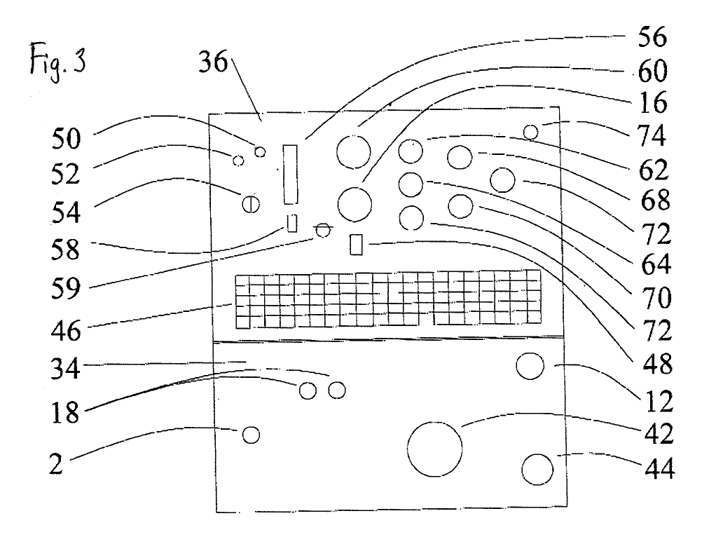

The present invention provides a slide-in truckmount vacuum unit that utilizes heated fluid for cleaning applications. A view of the interior of an embodiment of the present invention is depicted in FIG. 4 and the embodiment as a whole, which also includes front panels 34 and 36 and side panels 38 and 40 as depicted in FIG. 2, is identified generally with the numeral 1 and will be referred to hereafter as a truckmount.

As shown in FIG. 2, truckmount 1 includes a main frame 28, constructed of 3/16″ steel, which defines the spatial extent of truckmount 1 and upon which rests motor frame 29. Motor frame 29 includes laterally positioned blower mounts 30 and vertically extending motor mounts 32. As shown in FIG. 4, an engine 102 is mounted to motor mounts 32 and a blower 80 is mounted to blower mounts 30. Furthermore, a pump 10 is held fixedly above blower 80 by a horizontal platform mount affixed to blower 80. With reference to FIG. 2, motor frame 29 rests at both ends upon lateral supports of main frame 28, preserving space below motor frame 29 in which an accumulator pipe 6, silencer 42, engine exhaust heat exchanger 14, muffler 44, and other components may generally be positioned as depicted in FIG. 7.

Covering the main frame 28 are steel, right and left covers 38 and 40 containing ventilating louvers by which ambient air may enter and exit the truckmount 1. Additionally, an aluminum top front cover 36 and steel bottom front cover 34 are fastened to the front of main frame 28. Top front cover 36 includes a ventilation grill 46 and multiple gauges, dials, and instruments which govern and monitor the operation of the truckmount 1. Among these are: pump clutch fuse 50, motor fuse 52, ignition key 54, chemical flow meter 56, pump on/off switch 58, blower oil valve 59, chemical vacuum gauge 60, solution pressure gauge 16, 3-way toggle switch 48, amp meter 62, engine water temperature gauge 64, solution temperature gauge 66, engine oil pressure gauge 68, hour meter 70, tachometer 72, and throttle 74. Bottom front cover 34 includes circular apertures positioned so as to accommodate the extension of inlet regulator 2, quick connects 18, silencer 42, pressure regulator 12, and engine exhaust muffler 44 through the planar region formed by the surface of cover 34. Welded to the underside of the main frame 28 are forklift receptacles 29, constructed of structural channel which is sized and positioned so as to be securely engaged by the standard fork of a fork-lift, thereby facilitating the safe and convenient transport of truckmount 1.

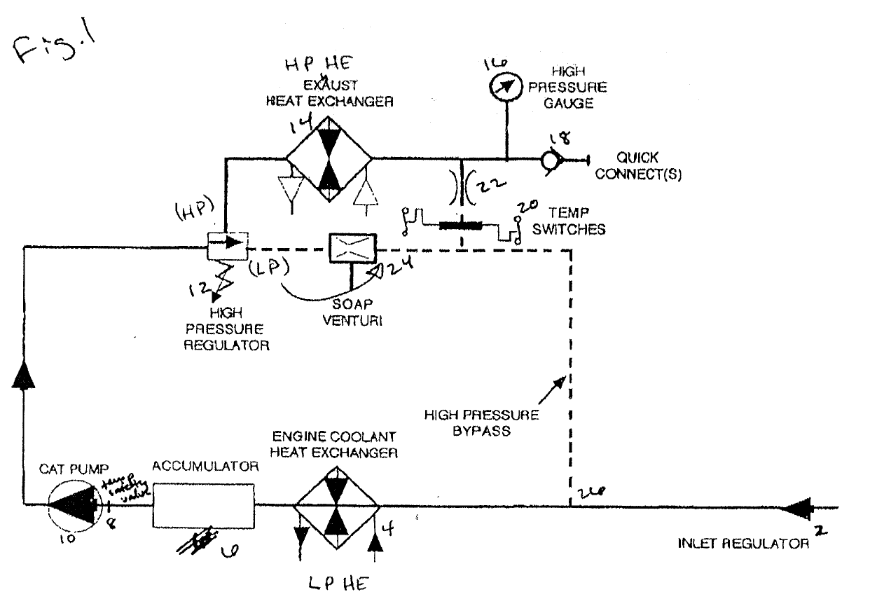

As truckmount 1 is a vacuum device which provides heated fluid for cleaning applications, its operation will be traced in relation to the flow of such cleaning fluid, hereafter referred to as solution. It should, however, be understood that solution may in practice alternatively be water or some other fluid. A flow diagram of solution in an embodiment of the present invention is depicted in FIG. 1.

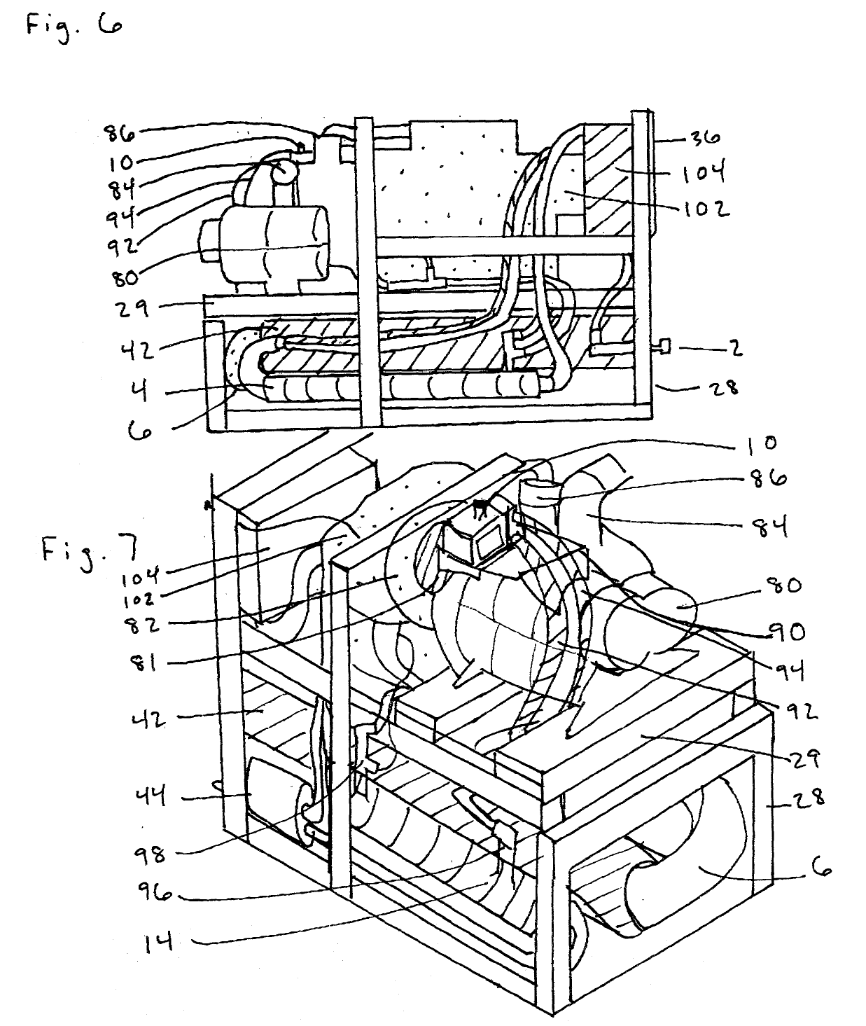

Typically, solution enters truckmount 1 via a quick connect inlet regulator 2 to which a standard garden hose may be affixed. From inlet regulator 2, solution travels through a three-quarter inch diameter rubber hose to engine coolant heat exchanger 4. This radiator heat exchanger 4, shown in FIG. 6, comprises a copper pipe containing solution and a surrounding steel shell containing engine coolant. The one-quarter inch diameter copper pipe is coiled within the three inch diameter steel shell through which engine coolant liquid flows in a direction opposite to the axial flow of solution. In this manner, the surrounding engine coolant liquid, which is heated by engine operation, imparts radiator heat to the copper coil and, in turn, to the solution as well throughout the two foot length of the heat exchanger 4. Due to the counter-flow arrangement of the pipes composing heat exchanger 4, unheated solution comes into thermal contact with the engine coolant liquid at its lowest temperature and subsequently departs heat exchanger 4 while in contact with engine coolant at its highest temperature. This design ensures that solution is heated gradually and that it exits heat exchanger 4 at the maximum temperature possible.

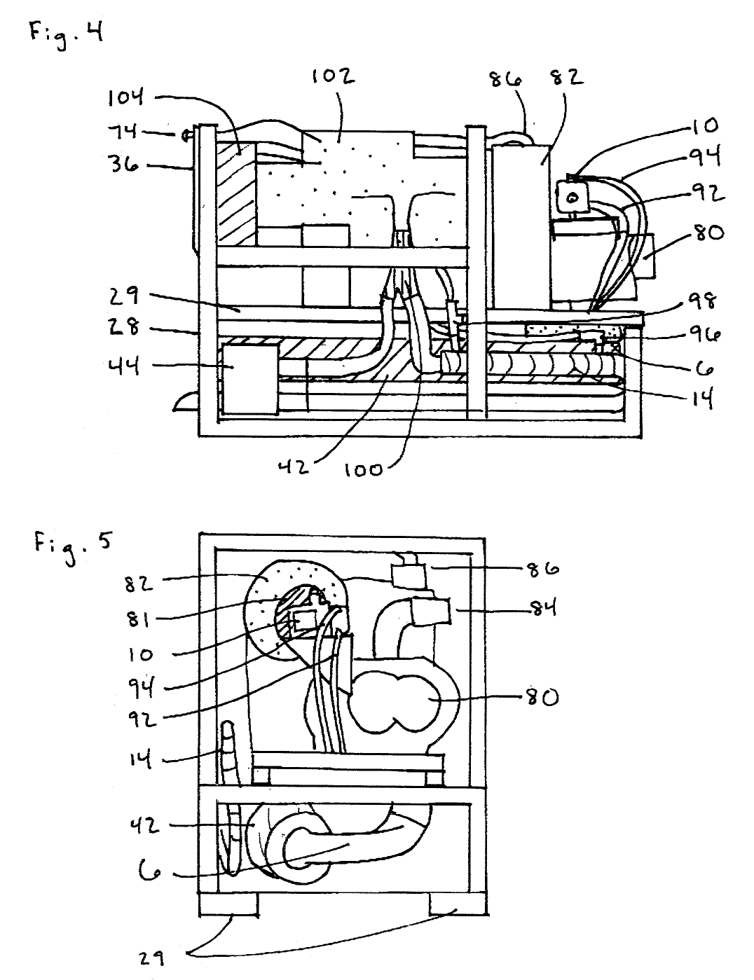

After leaving the engine coolant heat exchanger 4, solution enters an accumulator tank 6, consisting of four-inch copper pipe, which functions as a heat sink and provides adequate solution-holding capacity due to the size of the heat exchanger 4. The accumulator 6 may either be positioned to the front or the rear of silencer 42. From the accumulator 6, solution encounters a 180° Fahrenheit factory-set temperature relief valve 8 that expels overheated water to a waste tank, thereby protecting the remainder of the truckmount system. Following the relief valve 8, solution enters a high pressure plunger pump 10 via hose 92, as depicted in FIG. 4. Plunger pump 10, which incorporates clutch 81 shown in FIG. 5 and FIG. 7, is typically Cat Pumps® model 5CP2150W, rated at 5.0 GPM with maximum discharge pressure of 2000 PSI. The plunger pump 10 creates a high pressure system in the truckmount 1, providing for the eventual pressurized outflow of solution through external cleaning wands.

Subsequent to plunger pump 10, solution flows via hose 94 to a high pressure regulator 12, which may typically be either Cat Pumps® model 7570 or 7572. These models provide flow ranges of 2.5-7.8 and 2.5-7.0 GPM and pressure ranges of 150-1450 and 850-3450 psi, respectively. The handle of the pressure regulator 12 facilitates adjustment in order to easily achieve the desired pressure setting. From the pressure regulator 12, the system splits into high and low pressure branches.

Solution in the low pressure branch is diverted through a soap venturi 24, which typically injects a cleaning chemical into the solution stream. The soap venturi 24 utilized in the system is a standard downstream chemical injector. From soap venturi 24, solution recirculates to the low pressure solution intake system, being infused into said system at joint 26 prior to its introduction to engine coolant heat exchanger 4, as depicted in FIG. 1.

In contrast, the high pressure solution branch flows onward through one-half inch diameter rubber hose to encounter an engine exhaust heat exchanger 14 at elbow 96, as shown in FIG. 4. High pressure heat exchanger 14 is identical in design and function to its low-pressure counterpart 4, with the exception that the heating medium present within its outer three-inch diameter steel pipe consists of engine exhaust rather than engine coolant. Solution flows out of heat exchanger 14 through a brass T-shaped temperature sensor 98 that controls the solution temperature gauge 66 on the top front cover 36 of the unit.

The solution heating system of truckmount 1 includes an automatic control mechanism to maintain the consistency of solution output temperatures by regulating the diversion of engine exhaust away from the high-pressure heat exchanger 14. When necessary, the flapper valve located inside a two inch, cast iron, Y-shaped diverter valve assembly 100 is pulled by a temperature-controlled vacuum switch in order to bypass engine exhaust around the heat exchanger 14 and prevent excessive solution heating. The redirected exhaust travels to the muffler 44 by an alternate route, where it is expelled from the system. Significantly, the vacuum switching mechanism incorporated in an embodiment of the present invention is not dependent upon solenoids or other electrical sensors for successful operation. As a result of its simple design, it provides consistent, trouble-free temperature control.

The alternate temperature settings at which the vacuum switch can be actuated to pull the diversion valve are controlled by a simple 3-way toggle switch 48. In the middle, ‘off’ position of the toggle switch 48, the diversion valve is positioned in a stationary manner to continually bypass the engine exhaust around the heat exchanger 14. This setting produces a solution output temperature of about 180° Fahrenheit. The high and low ‘on’ positions of the toggle switch 48 each include two temperature switch leads 20 which run to the vacuum actuator in order to set the switching temperature of the diversion valve. The temperature switch leads 20 are located next to an orifice of restricted water back-flow 22, as depicted in FIG. 1, where the water temperature is measured. When in the high ‘on’ position, the vacuum switch operates to maintain a solution output temperature of about 235° Fahrenheit, an ideal cleaning solution temperature. In addition, the low ‘on’ position provides vacuum switching in order to maintain a solution output temperature of about 195° Fahrenheit, a convenient alternative for more delicate, lower-temperature cleaning applications. In each case, ‘about’ should be understood to refer to an operational solution temperature range having limits, supposing correct use of the truckmount, not exceeding five degrees greater than or 15 degrees less than the desired temperature.

The previously taught temperature ranges are applicable when the truckmount is correctly operated with either a single standard solution wand or with dual solution wands having reduced jets, as is common in the art. It should be emphasized that the function of the automatic engine exhaust diversion mechanism is to limit output solution temperatures to within five degrees above the desired temperature. However, incorrect use of the truckmount, such as requiring excessive solution output through large dual wands or not maintaining sufficient engine rpm, may cause the solution output temperature to fall below its standard operational range.

After departing the engine exhaust heat exchanger 14, solution passes a high pressure gauge 16 and exits the internal truckmount system via quick connects 18. Quick connects 18 are solution ports designed to conveniently fasten, in water-tight manner, to the ends of two external hand-held cleaning wands.

An embodiment of the present invention typically utilizes a 43 horsepower, Nissan liquid-cooled engine 102 which is mounted, as previously taught, upon motor mounts 32 shown in FIG. 2. The engine 102 is started by key 54 located on top front cover 36 and is powered by an external 12 volt battery. The engine 102 runs a blower 80, mounted to blower mounts 30, which provides the vacuum mechanism of the truckmount 1 in order to recover heated solution dispensed by the dual external cleaning wands. The blower 80 is typically a model 5009 Competitor Plus™ rotary positive displacement air blower sold by Tuthill Pneumatics Group which is rated at 14 inches mercury. The “vacuum-in” port 84 of the blower 80, shown in FIG. 5, is generally connected to an external vacuum tank via an appropriately fitted hose.

Some truckmounts incorporate belt-driven blowers, which are inherently susceptible to the undesirable belt slippage, wear, and maintenance commonly associated with such belt-drives. In contrast, the depicted embodiment of the present invention includes a shaft-driven blower in order to provide powerful, reliable operation without the disadvantages that often accompany belt-drive mechanisms.

While some truckmount units utilize blower exhaust in a heat exchanger, an embodiment of the present invention does not do so for several reasons. A previous truckmount constructed by the inventor had incorporated such a blower exhaust heat exchanger. However, after altering the heating system design to coincide with that of an embodiment of the present invention, it was found that the absence of such a heat exchanger does not significantly alter the maximum solution output temperatures achieved by the truckmount 1. In addition, the absence of such a heat exchanger allows for the installation of a large blower exhaust silencer 42 while maintaining the light, compact design of the embodiment of the present invention. As a result, blower exhaust is channeled through just such a large silencer 42 before being expelled from the truckmount through an aperture in the top front cover 36. The use of silencer 42 ensures the quiet operation of the truckmount 1, a trait which is very desirable in domestic cleaning applications.

In an embodiment of the present invention, plunger pump 10 that pressurizes the solution line is generally belt-driven by engine 102. Belt guard 82 for plunger pump 10 is depicted in FIG. 4. A belt drive is used because engine 102 typically only has a single drive shaft which, as has been taught, is employed to drive blower 80. Also, the use of a belt drive in this application allows plunger pump 10 to be stepped-up and operated at an rpm which varies from that of engine 102.

Before operating a truckmount that is in accordance with an embodiment of the present invention, the truckmount is typically mounted in a vehicle and connected to an external 12 volt battery. To operate the truckmount, a water supply hose, commonly a standard garden hose, is affixed to quick connect inlet regulator 2. Then the throttle is opened partially by pulling throttle control 74 and engine 102 is started by turning ignition key 54. Once the engine starts, throttle control 74 is adjusted to maintain an engine rpm reading of 1500 on tachometer 72 while engine 102 warms up. After the engine warms up, as judged by engine water temperature gauge 64, the throttle control 74 is adjusted to maintain an engine rpm reading of about 2200 to 2500 on tachometer 72 in order to build up engine 102 heat and begin heating solution in heat exchangers 4 and 14. While the solution temperature, as measured by solution temperature gauge 66, is rising, external vacuum and solution hoses may be set up and affixed to the truckmount. Dual solution hoses may be affixed to quick connects 18 and a vacuum hose may be affixed to the vacuum tank via “vacuum in” 84. When the truckmount is ready for operation, the engine water temperature gauge 64 reads about 180° Fahrenheit and the engine oil pressure gauge 68 registers in the ‘good’ range. Pump on/off switch 58 is turned on and pressure regulator 12 is adjusted to establish an operational solution pressure between about 800 and 900 psi, as registered on solution pressure gauge 16. Solution output temperature is selected by setting three-way toggle switch 48, and throttle control 74 is adjusted to maintain an engine rpm of about 2300 as measured on tachometer 72. While the truckmount operates, chemical flow meter 56, vacuum gauge 60, amp meter 62, engine water temperature gauge 64, engine oil pressure gauge 68, tachometer 72, solution temperature gauge 66 and solution pressure gauge 16 are periodically monitored to ensure that the vacuum system functions correctly.

I claim:

1. A self-contained heated vacuum system designed for mounting in a vehicle, wherein the improvement comprises the combination of:
a liquid-cooled engine;
a shaft-driven blower;
dual, counter-flow heat exchangers, wherein the first and second heat exchangers are low- and high-pressure heat exchangers, respectively, and wherein said first and second heat exchangers are heated by engine coolant and engine exhaust, respectively;
a diversion assembly, in which engine exhaust may be channeled to bypass said second engine exhaust heat exchanger and travel directly to a muffler by which it is expelled from the vacuum system;
a temperature-controlled vacuum switch, wherein the actuation of said vacuum switch pulls a flapper valve located said diversion assembly to alternately direct engine exhaust toward or away from said second heat exchanger; and
a three-way toggle switch, in which the possible switching temperature settings of said vacuum switch are preset and by which one of said temperature settings may be alternately selected for operation.

2. The vacuum system of claim 1, wherein said temperature-controlled vacuum switch does not incorporate the use of solenoids or other electrical sensors.

3. The vacuum system of claim 2, wherein the middle ‘off’ position of said three-way toggle switch positions said flapper valve so that all engine exhaust continually bypasses said second heat exchanger, and wherein the high and low ‘on’ positions of said three-way toggle switch each include two electrical leads connected to said vacuum switch which set the switching temperature of said vacuum switch at about 235° Fahrenheit and 195° Fahrenheit, respectively.

4. The vacuum system of claim 3, wherein said two electrical leads adjoin an orifice of restricted water back-flow, located between said second heat exchanger and a high pressure gauge, wherein the water temperature measurement is taken which controls said vacuum switch.

5. The vacuum system of claim 4, wherein said vacuum system does not include a blower exhaust heat exchanger, but wherein the exhaust of said shaft-driven blower is channeled through a large silencer.

6. The vacuum system of claim 5, further comprising:
a main frame which defines the spatial extend of said vacuum system, said main frame being constructed of welded steel rods;
a base welded to the underside of said main frame, upon which said vacuum system is mounted, said base comprising a sheet of steel which extends the full length and width of said main frame; and
a pair of parallel, generally horizontally extending, forklift receptacles, said forklift receptacles being constructed of steel structural channel welded along the full length of both side edges of the underside of said base, being sized and positioned to be to securely engaged by a standard fork of a forklift.

7. The vacuum system of claim 6, further comprising a motor frame, said motor frame resting at both ends upon lateral steel supports of said main frame, thereby preserving a cavity below said motor frame within the confines of said main frame, and said motor frame comprising:
two generally horizontally extending parallel steel rods that run the length of said motor frame;
two generally horizontally extending parallel steel blower mounts that are positioned orthogonally with respect to said steel rods and which fixedly rest upon said steel rods at both ends; and
three L-shaped motor mounts, where the base of each L-shaped mount is affixed upon said motor frame and the remainder of each said motor mount extends generally vertically above said motor frame, two of the said motor mounts each being affixed upon one of the said steel rods and the third of the said motor mounts being affixed upon both of the said steel rods, one at either end.
